(19) United States
(12) Patent Application Publication
(10) Pub. No.: US 2010/0286296 A1
(43) Pub. Date: Nov. 11, 2010

(54) ANTI-TERMITE STYROFOAM PRODUCT AND METHOD OF MANUFACTURING THE SAME

(75) Inventors: Shuichi Tamai, Osaka (JP); Minoru Yonehara, Shiga (JP); Takatoshi Karino, Tokyo (JP)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/682,998

(22) PCT Filed: Oct. 14, 2008
(86) PCT No.: PCT/EP08/08669

§ 371 Date: Jul. 19, 2010

(30) Foreign Application Priority Data
Oct. 15, 2007 (JP) 2007-267672

(51) Int. Cl. C08J 9/232; C08J 9/00

(52) U.S. Cl. 521/120; 264/51

(57) ABSTRACT

The present invention relates to an anti-termite styrofoam heat insulation material which is safe for use with humans and animals and method for making the same. The material contains the insecticide Thiamethoxam.

The present invention relates to an anti-termite styrofoam product, and a method of manufacturing the same.

Styrofoam (i.e. foamed polystyrene) can be said to be a typical foamed resin. One styrofoam product is a heat insulation material for buildings, including wooden houses. However, the problem with the heat insulation material made of styrofoam is feeding damage caused by termites. The termites do not feed on styrofoam, but due to softness of styrofoam, the termites eat their way within the styrofoam insulation material for wood while making eating-produced passages in the heat insulation material. This results in remarkable reduction of the heat insulating function of the insulation material, and damage to buildings using the insulation material. To solve this problem, various methods have been proposed for imparting an anti-termite property to the heat insulation material made of styrofoam.

The styrofoam products include molded products and extrusion products. The step of manufacturing the molded products can be broadly classified into a step of manufacturing styrofoam beads by polymerizing styrene monomer and impregnating the polymerized styrene monomer with a foaming agent, such as a hydrocarbon gas, a prefoaming step (or a primary foaming step) of putting a group of polystyrene beads in a prefoaming machine (which may be called a pot, a can, or a tank), and stirring the polystyrene beads while heating the same by vapor, to thereby expand the polystyrene beads to several tens of times of their original volumes, an aging step of lowering the inner pressure of the prefoamed raw beads to an atmospheric pressure by letting the prefoamed raw beads stand, and a molding step (a secondary foaming step) of putting the aged prefoamed beads in a mold of a molding machine (mold), and heating the beads by vapor, to thereby fuse the beads together and form the fused beads into a predetermined shape.

Then, the anti-termite property is imparted to the heat insulation material by adding an anti-termite agent to the same. Time for adding the anti-termite agent to the heat insulation material is largely classified into a case in which the anti-termite agent is added in a polymerization stage, a case in which the anti-termite agent is added (attached or impregnated) before the prefoaming step after polystyrene is formed into beads, a case in which the anti-termite agent is added in the course of the prefoaming step, and a case in which the anti-termite agent is added (attached) before molding the polystyrene beads after prefoaming the same. All of these stages are well known to the person skilled in the art.

Further, although organophosphorus agents, such as phoxim and chloropyrifos, organochlorine agents, such as DDT and chlordane, carbamate-based agents, such as propoxur, pyrethroid-based agents, such as permethrin, tar-based agents, such as creosote oil, and so forth have been used as anti-termite agents, the organophosphorus agents are inhibited from being used due to their carcinogenic risk, while the chloropyrifos was inhibited from being used in housings as one of materials causing so called sick house syndrome.

Although conventionally, as disclosed in documents well known in the art, the organophosphorus agents have been proposed as anti-termite agents added to styrofoam by emphasizing high efficacy thereof, more emphasis has been progressively placed on safety of the anti-termite agents. For example, nicotinyl-based agents, fipronil, sodium borate and hinokitiol are all known agents disclosed in this context in the art.

As to in which stage an anti-termite agent should be added to raw polystyrene, it can be said that addition thereof in the polymerization stage is theoretically superior, but it can be said that this method suffers from a problem to be solved before being put to use, since a necessary amount of the anti-termite agent must be uniformly mixed to the raw polystyrene without obstructing a polymerization reaction.

Further, the method of attaching the anti-termite agent to the beads or impregnating the beads with the anti-termite agent before the prefoaming step suffers from the problem that it is difficult to evenly and uniformly add the anti-termite agent to each bead, the problem that the necessity of a drying step makes the method troublesome, or the problem that although the anti-termite agent is evenly and uniformly attached to the surface of each bead or the surface of the bead is evenly and uniformly impregnated with the anti-termite agent, a bulk (an apparent volume) of the bead is very much increased when the bead is foamed, which makes it difficult to manufacture an anti-termite styrofoam product such that the anti-termite property is uniformly dispersed at an appropriate density in the expanded state of the beads.

On the other hand, although the method of attaching the anti-termite agent to the prefoamed beads is advantageous in that the anti-termite agent can be evenly added to the beads since the anti-termite agent is added to beads which have already been largely expanded, this method otherwise causes a problem that it is difficult to say that the anti-termite agent efficiently exerts its effect since the anti-termite agent is hardly mixed into the beads, a problem of the costs and manufacturing efficiency since it requires a special adding machine having a spray function and a drying function, in addition to an existing manufacturing machine.

In comparison with these, the method of adding the anti-termite agent in the course of the prefoaming step is advantageous in that the anti-termite agent can be uniformly added to the beads without causing the problem of the costs and manufacturing efficiency, since the method enables the anti-termite agent to be added to the beads using the prefoaming machine necessary for manufacturing the styrofoam product without modifying the same. Therefore, it can be said that it is rational to add the anti-termite agent in the course of the prefoaming step from the viewpoints of an anti-termite effect and economy.

On the other hand, from the study of the type of the anti-termite agent, which is naturally required to have the function of exterminating termites, and safety to humans, animals, and environments, the sodium borate, for example, cannot be said to have complete safety since its toxicity to fish is classified into Class C when it is registered as an insecticide. On the other hand, hinokitiol, for example, has high safety, but according to an experiment by the present inventors, it could be hardly confirmed that hinokitiol has any anti-termite effect when it is added in such an amount that no influence is made on the foaming and fusion properties of the polystyrene beads. In contrast, the nicotinyl-based agents disclosed in the art have a high anti-termite function even with a small amount thereof, and are excellent in safety.

Now, as described above, although it is rational to add the anti-termite agent while prefoaming the polystyrene beads, the anti-termite agent is required to be uniformly and evenly added in a state in which it does not adversely affect the quality of the polystyrene beads.

Further, in general, the polystyrene beads are prefoamed by being heated by vapor, and therefore it is impossible to avoid the phenomenon that vapor is condensed to water due to a fall of the temperature thereof. As a consequence, water collects in the bottom of the prefoaming machine after a prefoaming operation. Although this water needs to be drained, it is difficult to prevent part of the anti-termite agent from being dissolved in waste water, and hence high safety of the water is required also in the aspect of processing of the waste water (it is preferable that the water is so safe as to be allowed to flow into a drain without being subjected to a special purification process). Further, it is also necessary to prevent degradation of working environments, so that it is not preferable to use a volatile anti-termite agent or solvent.

As described above, not every type of anti-termite agent can be used as the anti-termite agent added simultaneously with prefoaming of the polystyrene beads, but its suitability is required. Further, it is necessary to contrive the method of adding the anti-termite agent. The present invention has been made based on such knowledge.

The present invention relates to methods in which an anti-termite agent is added in the course of the step of prefoaming raw polystyrene beads by the prefoaming machine and the items ultimately produced. A first characteristic feature of the present invention is that thiamethoxam is used as the anti-termite agent (it should be noted that thiamethoxam has a chemical name of [3(2-8-chloro-1,3-thiazol-5-ylmethyl)-5-methyl-1,3,5-oxadiazinan-ylidene(nitro)amine] or [3-((2-chloro-1,3-thiazol-5-yl)methyl-N-nitro-1,3,5-oxadiazinane-4-imine], and a chemical formula thereof is [C₈H₁₀ClN₅O₃S]).

Thiamethoxam is poisonous to termites both by contact and oral ingestion. Thiamethoxam, which by percutaneous entry or oral ingestion, blocks a neurotransmitter (acetylcholine) of a termite to paralyze the termite and cause the same to die. Therefore, thiamethoxam is not fast-acting but slow-acting, and due to the slow effect of thiamethoxam, a termite which has come into contact with thiamethoxam returns to its nest to come into contact with other termites or termites come into contact with a termite killed by thiamethoxam, whereby the thiamethoxam is diffused or propagated to a large number of termites.

The polystyrene beads which have been prefoamed and have thiamethoxam attached thereto are put in the molding machine and heated whereby the beads are fused together and are molded into a predetermined shape to become a product.

Accordingly the present invention provides an anti-termite styrofoam product that is manufactured by prefoaming raw polystyrene beads, and then fusing the polystyrene beads to each other and shaping the polystyrene beads, by final foaming of the polystyrene beads in a molding machine, the anti-termite styrofoam product being configured such that thiamethoxam as an anti-termite agent added when executing prefoaming of the raw polystyrene beads is held on a surface and an inside of the product in a dispersed state, wherein the thiamethoxam is contained in a range of 100 to 1000 ppm by mass with respect to polystyrene.

The present invention still further provides a method of manufacturing an anti-termite styrofoam product, which comprises a step of prefoaming raw polystyrene beads by putting the raw polystyrene beads in a prefoaming machine, and stirring the polystyrene beads while heating the same by vapor, and a step of putting the prefoamed resin beads in a molding machine and finally foaming the resin beads to thereby fuse the resin beads together and at the same form the fused beads into a predetermined shape, wherein in the step of prefoaming the polystyrene beads, an anti-termite agent is added to the polystyrene beads being expanded, wherein the anti-termite agent is thiamethoxam, and wherein an aqueous solution or a suspension of the thiamethoxam is prepared in advance, and the aqueous solution or the suspension of the thiamethoxam is sprayed onto the resin beads being expanded while being stirred in the prefoaming machine.

The invention still further provides a method of manufacturing an anti-termite styrofoam product as described, wherein the aqueous solution or the suspension contains 0.1 to 10% of thiamethoxam in terms of weight ratio relative to water, and the aqueous solution or the suspension is added in an amount of 2 to 30% in terms of weight ratio relative to the polystyrene beads.

The present invention still further provides an anti-termite styrofoam product as described wherein the styrofoam is a plate-shaped heat insulation material for buildings.

The present invention still further provides a method of manufacturing an anti-termite styrofoam product as described wherein the styrofoam is a plate-shaped heat insulation material for buildings.

As described herein, the styrofoam product according to the present invention has thiamethoxam held on a surface thereof in a dispersed state, as an anti-termite agent added when executing the prefoaming. The styrofoam product has a characteristic feature that it contains 100 to 1000 ppm of the above-described thiamethoxam in terms of mass ratio (outer ratio) relative to polystyrene.

More essential characteristic features of the present invention consist in the manufacturing method. More specifically, as described, this manufacturing method is characterized in that when thiamethoxam is added in the course of the polystyrene bead-prefoaming step, an aqueous solution or a suspension of thiamethoxam is prepared in advance, as a specific means, and the aqueous solution or the suspension of thiamethoxam is sprayed on the group of polystyrene beads being expanded while being stirred in the prefoaming machine.

The present invention has various variations. Examples thereof include the invention as described which uses the above-described aqueous solution or suspension which contains 0.1 to 10% of thiamethoxam in terms of weight ratio relative to water, and adds the aqueous solution or the suspension in an amount of 2 to 10% in terms of weight ratio relative to the polystyrene beads.

The present invention can be widely applied to styrofoam products provided in locations that can be damaged by termites. Particularly, as described within this specification, the true value of the present invention is appreciated when it is applied to heat insulation materials which are used under floors or in walls, ceilings, and so forth, of buildings.

The present inventors have paid attention to thiamethoxam as an anti-termite agent which is provided with both a termite control performance and safety to humans and animals, and considers the use of the thiamethoxam as an anti-termite agent as one of the features of the present inventions. The thiamethoxam is a neonicotinoid compound, and has a high effect of exterminating ants, such as termites, although toxicity thereof against fish is classified into Class A when it is used as an insecticide, and its toxicity to humans, animals, and environments is very low.

On the other hand, the use of thiamethoxam as an anti-termite agent for styrofoam is disclosed in the art, however, is directed to manufacturing polystyrene beads containing thiamethoxam and foaming the polystyrene beads containing thiamethoxam, and hence it is necessary to manufacture the beads by a special method, which lowers the general-purpose properties, disadvantageously. In contrast, in the present invention, thiamethoxam is added in the course of the step of prefoaming polystyrene beads, and hence the type of usable polystyrene beads is not limited. This makes the present invention excellent in general-purpose properties.

Although the anti-termite effect of thiamethoxam becomes higher as a larger amount thereof is added, it is necessary to take economy into account since thiamethoxam is expensive. According to experiments by the present inventors, it was possible to confirm a conspicuous anti-termite effect when thiamethoxam was mixed with a polystyrene resin at a mixing ratio of approximately 100 ppm by mass (weight ratio). Although the anti-termite effect of thiamethoxam becomes higher as the amount of thiamethoxam used is increased, it can be said that a sufficient anti-termite effect is obtained by adding approximately 1000 ppm of thiamethoxam (addition of an excessively large amount of thiamethoxam only results in an increase in losses). From the viewpoints of economy and an anti-termite performance, the amount of thiamethoxam added is suitably 100 to 500 ppm, and a particularly suitable range is 300 to 600 ppm.

A purified product of thiamethoxam is a powder. To evenly attach thiamethoxam to the polystyrene beads, it is preferable to dilute thiamethoxam with a liquid and spray the diluted thiamethoxam. In this case, although it is envisaged to use an organic solvent, such as acetone, or alcohol as a diluent liquid, it is impossible to use an organic solvent or alcohol since they dissolve polystyrene.

In contrast, in the manufacturing method according to the present invention, water is used as a liquid for diluting thiamethoxam, and hence polystyrene is not dissolved or deteriorated. Further, water is nontoxic, and the toxicity of thiamethoxam is also low, so that even if thiamethoxam is mixed into waste water from the prefoaming machine, the waste water can be allowed to flow into a sewerage without performing a special purification process on the waste water. Furthermore, thiamethoxam does not degrade working environments even if it is evaporated. Further, the temperature of vapor used for prefoaming polystyrene beads is approximately 110 to 120° C., while the fusing point (decomposition temperature) of thiamethoxam is 139° C., and hence the property of thiamethoxam is stable. As described above, the fusing point of thiamethoxam is higher than the temperature of vapor, thereby making it possible to add thiamethoxam in the prefoaming step. This is one of the advantages in using thiamethoxam.

The group of innumerable polystyrene beads is prefoamed such that the volume (apparent volume) thereof is increased to a volume, for example, approximately 50 times as large as its original volume, and moreover the surface of the polystyrene bead is formed with a large number of irregularities, so that the total sum of the surface areas of the group of polystyrene beads in the prefoaming machine is very large. Therefore, to evenly attach thiamethoxam to the surface of each polystyrene bead, a suitable amount of an aqueous solution or a suspension of thiamethoxam is required. However, if the amount of the aqueous solution or the suspension is too large, there is a possibility that the temperature of vapor lowers to degrade the prefoaming efficiency of the polystyrene beads. Further, the loss of thiamethoxam flowing into waste water has to be suppressed as much as possible.

Therefore, the addition ratio of the aqueous solution or the suspension to the polystyrene beads, and the concentration of the aqueous solution or the suspension have suitable ranges. The present inventors have repeatedly carried out experiments to obtain the suitable ranges, and as claimed in claim 3, by setting the concentration of thiamethoxam in the aqueous solution or the suspension to 0.1 to 10% in terms of weight ratio relative to water, and the addition ratio of the aqueous solution or the suspension to the polystyrene beads to 2 to 30% in terms of weight ratio, the present inventors have obtained styrofoam having a high anti-termite property, without hindering prefoaming of the polystyrene beads.

The solubility (weight ratio) of thiamethoxam into water is 0.41% at one atmospheric pressure and 4° C. (that is, up to 4.1 g of thiamethoxam dissolves in 1 liter of water). Accordingly, if the concentration (outer percentage) of thiamethoxam is not higher than 0.41%, thiamethoxam is in the state of an aqueous solution, whereas if the concentration of thiamethoxam exceeds 0.41%, thiamethoxam is placed in the state of a suspension. In the present invention, both the aqueous solution and the suspension can be employed. In the case of the aqueous solution, thiamethoxam is completely dissolved in water, so that if only the aqueous solution is sufficiently stirred, and then is evenly sprayed on the group of the polystyrene beads, thiamethoxam can be attached to the group of the polystyrene beads in a uniformly dispersed manner.

The concentration of thiamethoxam in the aqueous solution should be at least 0.1%. When the concentration of thiamethoxam is low, it is required to increase the amount of sprayed aqueous solution to thereby ensure the addition ratio of thiamethoxam to the polystyrene beads. However, if the spray ratio of the aqueous solution to the polystyrene beads becomes too large, there arises the problem that the prefoaming of the polystyrene beads is hindered and waste water is increased. Therefore, it is preferable that the concentration of thiamethoxam is not lower than 0.1%. Suitably, the concentration is not lower than 0.2%.

On the other hand, there is a possibility that when the concentration of thiamethoxam becomes too high, the amount of the sprayed aqueous solution becomes smaller, which makes it difficult to evenly attach thiamethoxam to the group of the polystyrene beads. Further, when the concentration exceeds 0.41%, the aqueous solution is turned into a suspension. In the suspension, thiamethoxam exists in a solid state, so that if the concentration of thiamethoxam becomes too high, the dispersing property of thiamethoxam may be degraded. According to the observation of the present inventors, it was suitable that the concentration is not higher than 10%. In the suspension, there occurs a phenomenon that thiamethoxam precipitates with the lapse of time, and hence from the viewpoint of workability, it can be said that it is preferable to use a 0.2 to 0.41% aqueous solution.

There follows a description of an embodiment of the present invention. It should be noted that in the following description, when there is no need to separately describe an aqueous solution of thiamethoxam and a suspension thereof, they are generically referred to as “the aqueous mixture”. Further, “polystyrene beads” are sometimes simply referred to as the “beads”.

(1) Outline of a Manufacturing Process

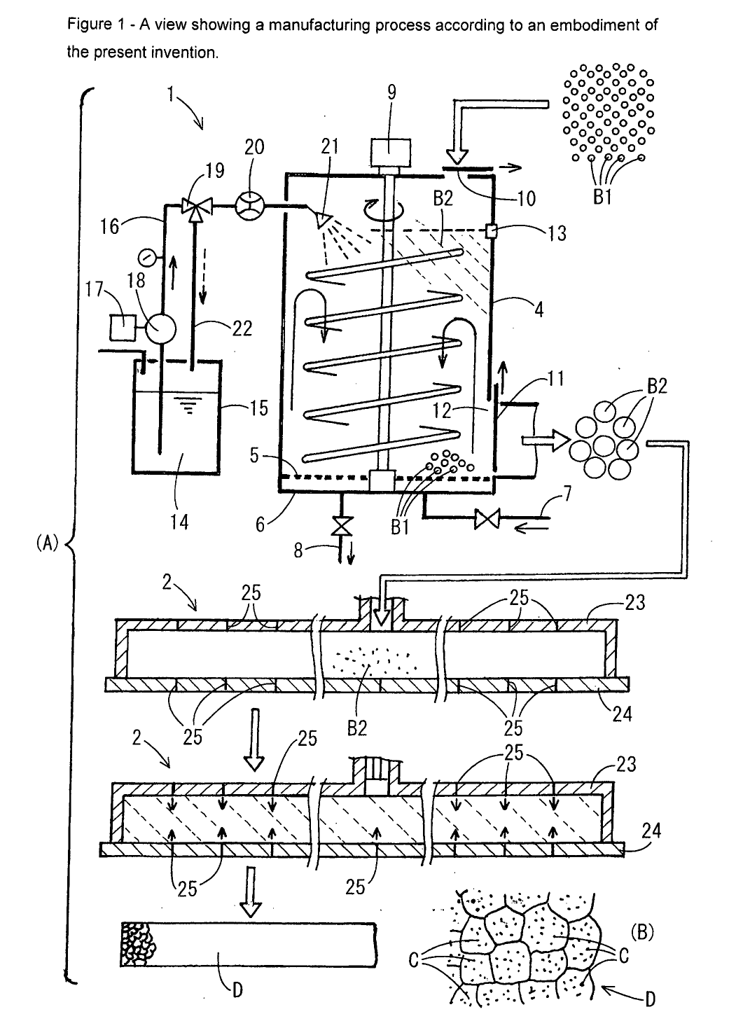

FIG. 1(A) schematically shows manufacturing equipment. First, a manufacturing step will be described with reference to FIG. 1(A). The present invention is applied to a method of manufacturing a heat insulation material for buildings. The step of manufacturing a styrofoam heat insulation material is essentially the same as the conventional one. First, raw beads B1 having a diameter of approximately 1 mm are manufactured by using styrene monomer as a raw material.

Next, the group of the raw beads B1 is placed in a prefoaming machine 1, and is prefoamed such that the volume thereof is made approximately 50 times larger than its original volume, to thereby form prefoamed beads B2. Then, the prefoamed beads B2 are aged by letting them stand for a certain time period. Subsequently, the aged prefoamed beads B2 are heated in a molding machine (mold) 2 and finally foamed, whereby adjacent ones of the beads B2 are fused together, and shaped into a heat insulation material D.

Although prefoaming machines include a batch type machine, a continuous type machine, and so forth, the present embodiment uses the batch type prefoaming machine 1. This prefoaming machine 1 has a hollow cylindrical body (cauldron) 4 containing a screw-type stirring blade 3. The body 4 includes a lower plate 5 formed with a large number of small holes. A vapor pipe 7 is connected to a space between the lower plate 5 and a bottom plate 6. Further, a drain pipe 8 is connected to the bottom plate 6 of the body 4. The stirring blade 3 is driven by a motor 9.

An inlet port 10 is formed in a desired portion (a ceiling portion, in the illustrated example) of the body 4. Further, a discharge port 12 having a lid 11 is formed in an outer periphery of a lower portion of the body 4 such that the prefoamed beads B2 are discharged from the discharge port 12 into an aging can by a pneumatic conveyor. Provided in an upper portion inside the body 4 is a level meter (sensor) 13 for detecting the amount of the prefoamed beads B2. When the group of the prefoamed beads B2 rises to the height of the level meter 13, the injection of the vapor stops (the injection of the vapor can be controlled by time).

The body 4 has a tank 15 for storing an aqueous mixture 14 of thiamethoxam, as equipment for carrying out the present invention. The tank 15 and an upper portion of the body 4 are connected by a water pipe 16. The water pipe 16 is provided with a pump 18 driven by a motor 17, an electromagnetic three-way valve 19, a flow meter 20, and a spray head 21 for forming the aqueous mixture 14 into a mist and spraying the same into the inside of the body 4. When a predetermined amount of the aqueous mixture 14 is sprayed on the beads B1 and B2, the aqueous mixture 14 circulates from the three-way valve 19 into the tank 15 via a return pipe 22.

The molding machine 2 includes a fixed mold 23 and a movable mold 24 as main members. The molds 23 and 24 are formed with a large number of vapor injection holes 25. When heating-fusion is terminated, the heat insulation material D is cooled by water in a state placed in the molding machine 2 so as to prevent the heat insulation material D from being expanded by remaining heat.

FIG. 1(B) is a schematic cross-sectional view of the inside of the heat insulation material D. As shown in the figure, the heat insulation material D is constructed by a collection of innumerable cells C each of which corresponds to one of the beads B1 and B2, wherein adjacent ones of the cells C are fused together (since each cell C has innumerable closed cells, a large number of (innumerable) foams exist in boundaries where cells C overlap each other).

The raw beads B1 turn into the prefoamed beads B2, while being expanded in the prefoaming step. In the course of the expansion, the aqueous mixture 14 of thiamethoxam is directly sprayed on the surfaces of the raw beads B1, and when the beads B1 are brought into contact with each other while flowing, the aqueous mixture 14 of thiamethoxam is transferred to one place to another, whereby the aqueous mixture 14 is substantially uniformly applied on the surfaces of the prefoamed beads B2. As a consequence, barrier layers of thiamethoxam are formed also on surface portions of the respective cells C that form the heat insulation material D.

As described above, since thiamethoxam is substantially uniformly dispersed on the surface portions of the respective cells C, termites reliably come into contact with thiamethoxam when they eat the heat insulation material D in their courses within the heat insulation material D. This makes it possible to efficiently terminate termites.

(2) Method of Experiment and Result

Next, a description will be given of Example of the styrofoam heat insulation material manufactured by using the above-described actual machine. In this Example, the weight of the raw beads B1 used was 21.5 kg, and the foaming magnification by the prefoaming machine 1 was approximately 50 times. As the thiamethoxam was used thiamethoxam (powder) of 100% purity, manufactured by Syngenta Japan K.K. who is one of the present applicants. The thiamethoxam was mixed with water to make an aqueous solution of the same.

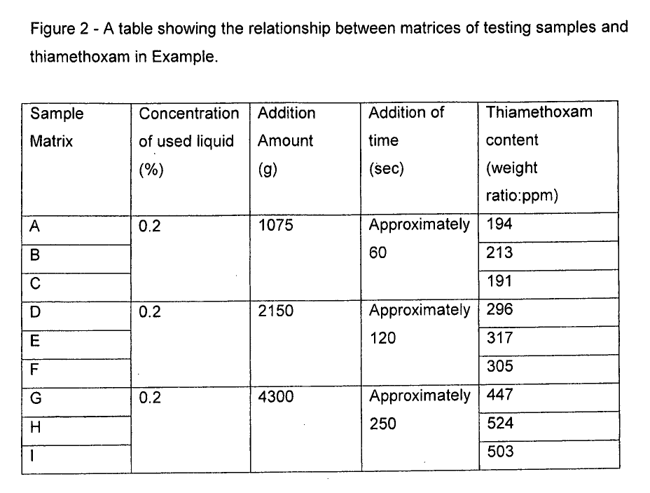

Matrices shown in FIG. 2 (Table 1) were manufactured as matrices of testing materials. A to C represent heat insulation materials manufactured by the same batch. An aqueous solution of which the concentration of thiamethoxam was 0.2% was made, and added to the 21.5 kg of polystyrene beads over approximately 60 seconds in the prefoaming step. Three test pieces each having a weight of approximately 5 g were cut out from the respective matrices, and the thiamethoxam contents of the test pieces were measured by an HPLC method. Average values of the inspection results are shown in FIG. 2 (Table 1) (the same applies to the other matrices).

D to F represent heat insulation materials manufactured by the same batch. An aqueous solution of 2150 g of which the concentration of thiamethoxam was 0.2% was added over approximately 120 seconds. Furthermore, G to I as well represent heat insulation materials manufactured by the same batch. An aqueous solution of 4300 g of which the concentration of thiamethoxam was 0.2% was added over approximately 250 seconds.

It should be noted that the thiamethoxam contents of A to C were approximately 200 ppm, those of D to F were approximately 300 ppm, and those of G to I were approximately 500 ppm. Therefore, for convenience of description, A to C can be classified as a low content group, D to F as a medium content group, and G to I as a high content group. The thiamethoxam contents appearing in Table 2 are actually measured values. Since losses occur during manufacturing of each heat insulation material, the weight (concentration×addition amount) of thiamethoxam in use, relative to the weight (21.5 kg) of the raw beads does not accurately match.

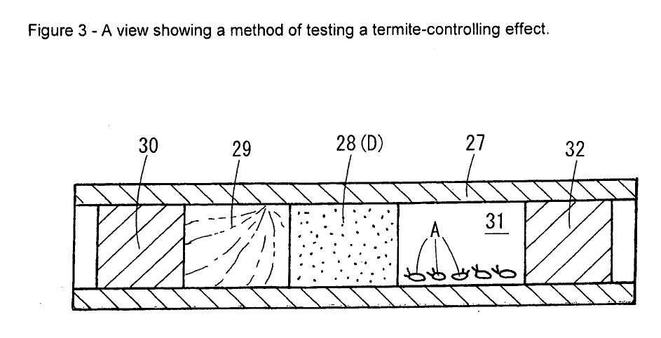

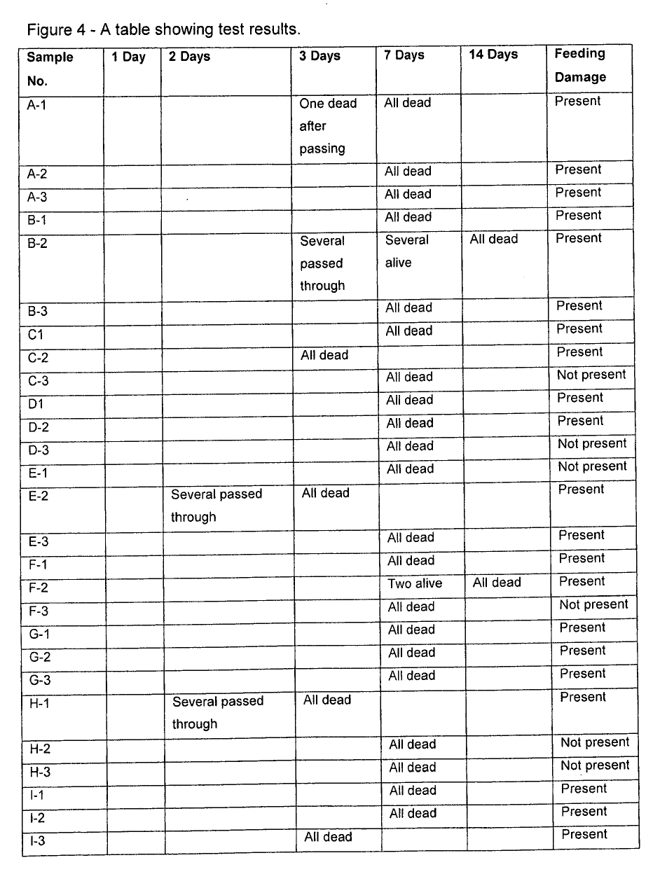

Three pieces of samples were cut out from the respective matrices of the testing materials, and experiments of feeding damages by formosan subterranean termites were carried out thereon. More specifically, as shown in FIG. 3, transparent pipes 27 made of polytetrafluoroethylene were prepared. Each of samples 28 (A1 to I3) having a length of approximately 20 mm was put into an intermediate portion of one of the transparent pipes 27. Wood (Japanese red pine) 29 was disposed as bait on a side of the sample 28 toward one end the pipe 27, and the one end was sealed by agar. On the other hand, a space 31 having a length of approximately 30 mm was formed on a side of the sample 28 toward the other end of the pipe 27 and 100 formosan subterranean termites A were put into the space 31. Furthermore, the other end of the pipe 27 was sealed by agar, and then the states of the termites A and the sample 28 were observed by naked eyes as time lapses. The results are shown in a table in FIG. 4.

As can be understood from FIG. 4, all the termites were dead on the seventh day except in a small number of the samples, which proves the effect of the present invention. Further, it can be understood from the table in FIG. 4 that the effect of extermination of the termites becomes higher as the content of thiamethoxam increases. Particularly from the fact that all the termites were killed in the samples of C, D, E, F, and H without any feeding damage, it can be understood that the effects of the present invention becomes conspicuous from the boundary of the thiamethoxam content of approximately 300 ppm.

It should be noted that although certain variations are observed in the thiamethoxam contents, the presence or absence of feeding damage, and lethal effect on termites, it is estimated that the reasons therefor are that even in the matrix of one sample, there is a certain difference in the thiamethoxam content depending on locations of the matrix, that the samples are sometimes liable to feeding damage due to cuts formed when they are cut out, and that the activities of termites vary depending on the samples. Anyway, it is clear that the variations are not so significant as to deny the significance of the present invention.

(3) Others

In the present invention, it is also possible to add additives other than the thiamethoxam to the aqueous mixture, such as antifungal agent, antiseptic, flame retardant, antistatic agent, and antibacterial agent. If the aqueous mixture is colored by adding dye (or pigment) thereto, it is also possible to color styrofoam products. If the aqueous mixture is colored, it is possible to visually confirm whether or not thiamethoxam is evenly attached to prefoamed polystyrene beads. Further, by cutting a product and observing an inside thereof, it is also possible to visually confirm a dispersed state of thiamethoxam.

Further, the coloring of a styrofoam product with a specific color is advantageous also in that it is possible to indicate that it is an anti-termite styrofoam product (in this case, if a plurality of types of anti-termite styrofoam products are manufactured which are different in the addition ratio of thiamethoxam and hence different in the anti-termite grade therebetween, it is also possible to distinguish the anti-termite grades by colors).

Further, the present invention does not preclude mixture of an anti-termite agent other than thiamethoxam. However, safety to humans, animals, and fish should be taken into account, and hence even if a component other than thiamethoxam is to be mixed, one having very low toxicity to humans, animals, and fish, such as neonicotinoid agents, should be used.

Furthermore, in the present invention, it is also possible to stop the injection of vapor after termination of prefoaming of polystyrene beads in the prefoaming machine, and further continue to add the aqueous mixture of thiamethoxam while stirring polystyrene beads. Although a continuous type machine can also be used as a prefoaming machine, it is preferable to use a batch type machine since the batch type machine is capable of positively and evenly spraying an aqueous solution or a suspension on polystyrene beads.

### DESCRIPTION OF REFERENCE NUMERALS IN FIGURES

A (in FIG. 2) termite
B1 raw beads
B2 prefoamed beads
D heat insulation material for buildings, as an example of styrofoam
1 prefoaming machine
2 molding machine
3 stirring blade
4 body
7 vapor pipe
8 drain pipe
13 tank
14 aqueous mixture of thiamethoxam
16 water pipe
19 spray head
21, 22 molding mold (mold)

1. An anti-termite styrofoam product that is manufactured by prefoaming raw polystyrene beads, and then fusing the polystyrene beads to each other and shaping the polystyrene beads, by final foaming of the polystyrene beads in a molding machine, the anti-termite styrofoam product being configured such that thiamethoxam as an anti-termite agent added when executing prefoaming of the raw polystyrene beads is held on a surface and an inside of the product in a dispersed state, wherein the thiamethoxam is contained in a range of 100 to 1000 ppm by mass with respect to polystyrene.

2. A method of manufacturing an anti-termite styrofoam product, which comprises a step of prefoaming raw polystyrene beads by putting the raw polystyrene beads in a prefoaming machine, and stirring the polystyrene beads while heating the same by vapor, and a step of putting the prefoamed resin beads in a molding machine and finally foaming the resin beads to thereby fuse the resin beads together and at the same form the fused beads into a predetermined shape, wherein in the step of prefoaming the polystyrene beads, an anti-termite agent is added to the polystyrene beads being expanded, wherein the anti-termite agent is thiamethoxam, and wherein an aqueous solution or a suspension of the thiamethoxam is prepared in advance, and the aqueous solution or the suspension of the thiamethoxam is sprayed onto the resin beads being expanded while being stirred in the prefoaming machine.

3. A method of manufacturing an anti-termite styrofoam product according to claim 2, wherein the aqueous solution or the suspension contains 0.1 to 10% of thiamethoxam in terms of weight ratio relative to water, and the aqueous solution or the suspension is added in an amount of 2 to 30% in terms of weight ratio relative to the polystyrene beads.

4. An anti-termite styrofoam product according to claim 1 wherein the styrofoam is a plate-shaped heat insulation material for buildings.

5. A method of manufacturing an anti-termite styrofoam product according to claim 2 wherein the styrofoam is a plate-shaped heat insulation material for buildings.
